(19) United States
(12) Patent Application Publication
(10) Pub. No.: US 2008/0033724 A1
(43) Pub. Date: Feb. 7, 2008

(54) Method for generating a context-based voice dialogue output in a voice dialog system

(75) Inventors: Hans-Ulrich Block, Munich (DE); Stefanle Schachtl, Alling (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/882,728

(22) Filed: Aug. 3, 2007

(30) Foreign Application Priority Data
Aug. 3, 2006 (DE) 10 2006 036 338.8

(51) Int. Cl. G10L 15/22

(52) U.S. Cl. 704/257; 704/E15.04

(57) ABSTRACT

The user friendliness of voice dialog systems is increased by drawing the user's attention in a context-based manner to additional themes modeled in the system during the dialog, so this additional information has a content-related connection with the instantaneous actions of the user. A conversation character which, to a certain extent, can suggest intelligent, easy conversation with different threads, can thus be imitated in the voice dialog system.

### CROSS REFERENCE TO RELATED APPLICATIONS

This application is based on and hereby claims priority to German Application No. 10 2006 036 338.8 filed on Aug. 3, 2006, the contents of which are hereby incorporated by reference.

### BACKGROUND OF THE INVENTION

The invention relates to a method for generating a context-based voice dialog output in a voice dialog system and to a method for creating a voice dialog system from a plurality of voice dialog applications.

Voice dialog systems for database accesses which allow information accesses and control of communication applications via voice communication are used in interfaces to many computer-aided applications. Applications or background applications, such as a technical device in consumer electronics, a telephonic information system (railway, flight, cinema, etc.), a computer-aided transaction system (home banking system, electronic goods ordering, etc.) can to an increasing extent be operated as access systems via voice dialog systems of this kind. Such voice dialog systems can be produced in hardware, software or in a combination thereof.

The course of the dialog for generating application-specific dialog aims is controlled in this connection by the voice dialog system which manages interactions between a dialog management unit and the respective user. The information input or information output takes place in this connection via an input unit and an output unit which are connected to the dialog management unit.

An utterance in the form of a voice signal and generated by a user is conventionally detected by the input unit and processed further in the dialog management unit. A voice recognition unit for example is connected to the input unit via which action information contained in the detected user utterance is determined. To output what are known as action prompts or information prompts, i.e. preferably speech-based instructions or information, to the user, the output unit can comprise a voice synthesis unit and have a “text-to-speech” unit for converting text into speech.

Different information can be retrieved or different aims pursued in a voice dialog system via different background applications or voice dialog applications. One such background application should be conceived in this connection as a finite quantity of transactions, a finite quantity of transaction parameters being associated with each transaction. A finite quantity of parameter values respectively is in turn associated with the transaction parameters. The transaction parameters are known to the voice dialog system and are detected in dialog with the user via a grammar specifically provided for the individual transaction parameters. In this connection the user can for example name the desired transaction and the associated transaction parameters in a sentence or not. In the first case the transaction can be carried out immediately and in the second case detection of the still unknown parameter is required in dialog with the user. If it is not possible to clearly determine a transaction by way of the user's utterance, the system automatically carries out a clarification dialog to determine the desired transaction. The same applies to unclear and incomplete user information with respect to a transaction parameter.

A dialog specification is associated with each background application or voice dialog application and comprises a transaction database, a parameter database and a grammar database.

Each individual background application is executed by one associated voice dialog system respectively by evaluating the respectively associated dialog specification. It is known for example to uniformly operate a plurality of different background applications or voice dialog applications by way of a common voice dialog system. However a universal dialog system of this kind presupposes that the user is already familiar with the individual applications or functionalities in order to be able to use the universal dialog system to its full extent. Previously, for a user of a voice dialog system of this kind there existed only the possibility of having all applications, available in the respective voice dialog system, enumerated in an information prompt.

From the user's perspective it is therefore desirable to increase the user friendliness of voice dialog systems of this kind by drawing the user's attention in a context-based manner to additional themes modeled in the system during the dialog, so this additional information has a content-related connection with the instantaneous actions of the user. A conversation character which, to a certain extent, can suggest intelligent, easy conversation with different threads, can thus be imitated in the voice dialog system.

### SUMMARY

One potential object therefore relates to a method with which a context-based voice dialog output is generated in a voice dialog system. Specifications with respect to the limited vocabulary size of available voice recognition systems should be considered when creating a method comprising conversational dialog behavior of this kind.

A further potential object lies in disclosing a method with which voice dialog applications which are suitable for a context-based voice dialog system that embraces such a theme can be identified and combined.

The inventors propose that transactions and transaction parameters are associated with a voice dialog system and a plurality of parameter values is associated with the transaction parameters respectively. In the method for generating a context-based voice dialog output a transaction parameter of a first transaction is associated with a first parameter value. At least one second transaction is determined using a second transaction parameter whose quantity of parameter values includes the first parameter value. A second parameter of a further transaction parameter of the second transaction is determined, it being possible to thematically associate the second parameter value with the first parameter value. Finally, a voice dialog output is generated which comprises at least the first parameter value and the second parameter value. The method has the advantage that it gives the user the impression of freer communication with the voice dialog system and thus considerably increases user acceptance of the voice dialog system. The method also has the advantageous effect that in voice dialog systems or voice dialog portals with a large number of voice dialog applications and/or a large number of modeled themes, a long system monologue to explain the applications provided by the voice dialog system can be avoided since this monologue often fatigues the user and is difficult to understand. Instead the method points out further possibilities to the user, which possibilities are provided for him by the system, in an entertaining manner using the automatically generated voice dialog outputs.

According to the method for creating a voice dialog system from plurality of voice dialog applications a relationship test is carried out between individual voice dialog applications using a predefinable criterion. The voice dialog applications, which satisfy the predefinable criterion, are combined in a voice dialog system. The method has the advantage that voice dialog applications, which are related thematically and content-wise, can be easily identified and combined and thus considerably facilitate orientation and effective use of the possibilities offered to the user by the voice dialog system within the framework of a conversational voice dialog system.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of a method for creating a voice dialog system from a plurality of voice dialog applications,

FIG. 2 shows a schematic illustration of a method for generating a context-based voice dialog output in a voice dialog system,

FIG. 3 shows standardized tables containing information on kingdoms, German federal states and gambling houses.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

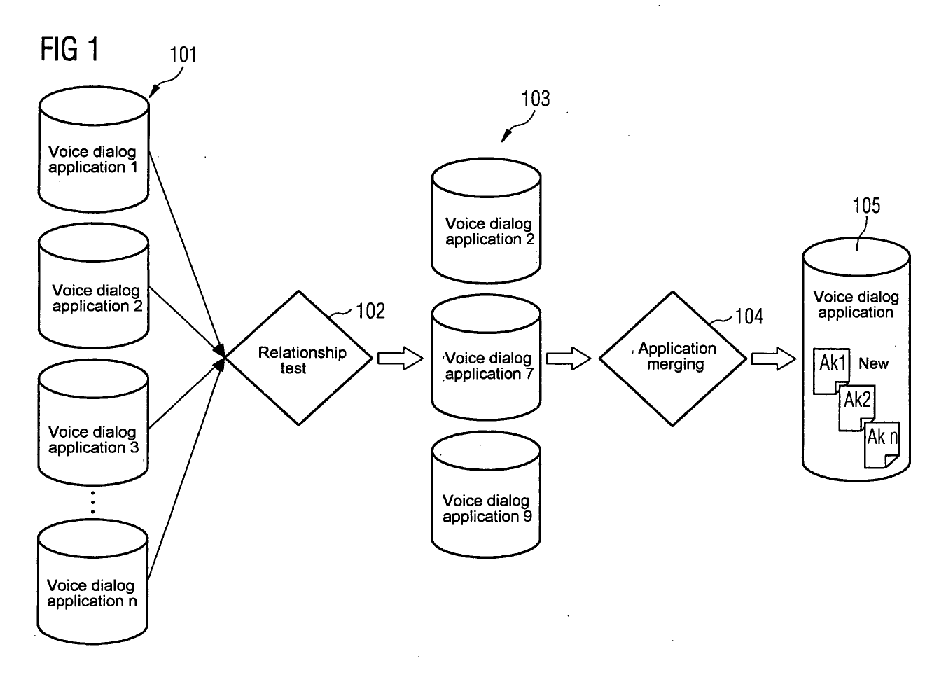

FIG. 1 shows in a schematic illustration a method for creating a voice dialog system from a plurality of voice dialog applications. In a first step a subset of voice dialog applications, which on the basis of predefinable criteria are categorized as being related 102 to each other, is automatically filtered from a plurality of voice dialog applications 101. These voice dialog applications can themselves again have been automatically generated. A criterion for selection of voice dialog applications can be for example that the vocabularies of the individual voice dialog applications match to a significant extent. In this connection it is possible to determine by way of experiments for example how large the overlap in individual vocabularies has to be for the voice dialog applications to be categorized as thematically related. The voice dialog applications 103 determined in this way are combined in a further step, for example using an application merger 104, to give a voice dialog system 105.

There are then transactions in the newly generated voice dialog system which correspond to the former voice applications. In the simplest case, if every original voice dialog application had only one transaction and all voice dialog applications were not similar in the sense of merging, there are as many transactions as voice dialog applications merged or combined in the newly generated voice dialog system. By way of example: there are three voice dialog applications which were automatically generated from three different tables. The first table contains information about European kingdoms, a second table information containing statistical and general data on the German federal states and a third table information on gambling houses in Germany. On the basis of their at least partially shared vocabulary the three voice dialog applications which have been produced from these tables are identified in the process shown in FIG. 1 as candidates for application merging. A new voice dialog system, which comprises the three transactions “Kingdoms”, “Federal states” and “Gambling houses”, is automatically generated herefrom in the application merging 104. The transaction “Kingdoms” comprises the transaction parameters “Period”, “Dynasty” and “Kingdom” and the transaction parameter “Dynasty” comprises for example the parameter values “Bourbons”, “Wittelsbacher” and “Tudors”.

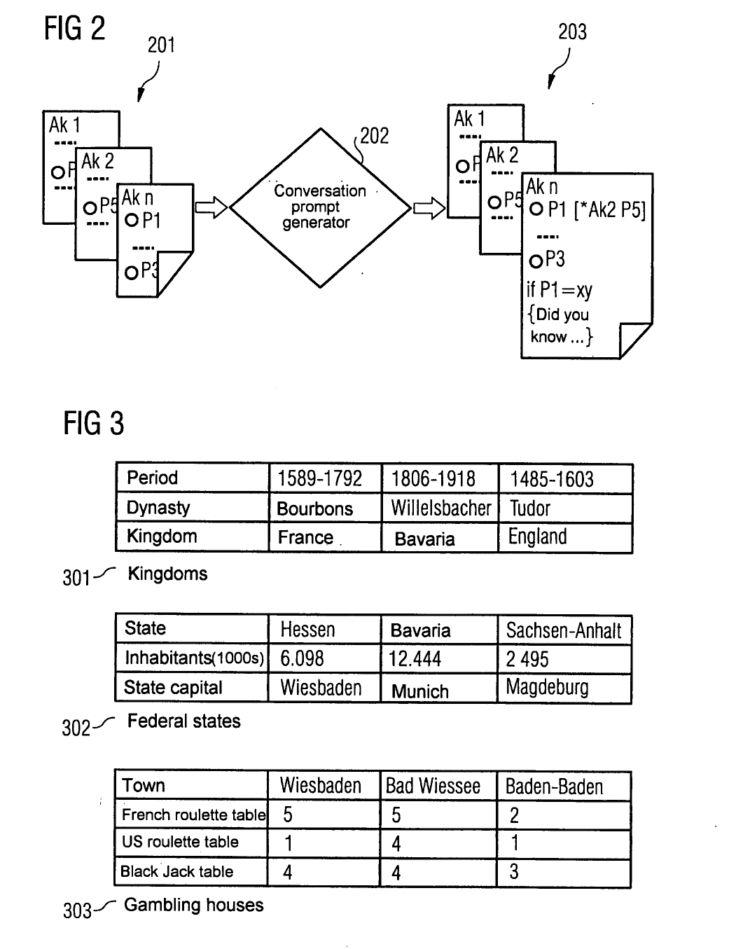

FIG. 2 shows in a schematic illustration a method for generating a context-based voice dialog output in a voice dialog system. In a first step 201 a first parameter value is known. This parameter value can, for example, have been identified in a user's voice input. The parameter values of all remaining transactions are accordingly checked in the first step for matches with the first parameter value. A voice dialog output, in which reference is made to further transactions offered by the system, is generated on the basis of the matches found in a conversation prompt generator 202. This voice dialog output is output by the voice dialog system in a last step 203.

The method for determining the conversation prompt can proceed for example as follows:

In a first step it is checked whether there are additional transactions in the voice dialog system which comprise a transaction parameter that can also assume the first parameter value. A further transaction parameter of the found transaction is then selected and the parameter value which can be thematically allocated to the first parameter value is determined. Finally a conversation prompt is generated in which reference is made to the second parameter value connected to the first parameter value.

An exemplary voice dialog output, which is generated with the method, will be presented hereinafter with reference to FIG. 3. First of all the voice dialog system introduces itself to the user in a greeting prompt, for example using the words “Hello, here is your general information system”. I can give you information about kingdoms 301 and, more precisely, about period, dynasty and kingdom. For example why don't you ask me: what do you know about the Bourbons?”. Thus at the start of the dialog the user is given a portion of the potential information that can be retrieved via the voice dialog system.

The user then turns to the system with the question “What were the kings of Bavaria called?”. In this case the voice dialog system recognizes the parameter value “Bavaria” and according to the method described in FIG. 2 searches in the remaining transactions “Federal states” 302 and “Gambling houses” 303 for this first parameter value “Bavaria”. The voice dialog system finds the parameter value “Bavaria” in the transaction “Federal states” 302 under the transaction parameter “State”. From the transaction “Federal states” 302 the voice dialog system then selects an additional parameter value which can be associated with the first parameter value “Bavaria”. In this exemplary embodiment “Munich” is chosen as the second parameter value from the transaction parameter “State capital” of the transaction “Federal sates” 302. Finally, the voice dialog generates the conversation prompt “Incidentally, did you know that+transaction parameter2+is+second parameter value+of+first parameter value+?”, so the voice dialog system outputs the voice output “Incidentally, did you know that Munich is the state capital of Bavaria?”. It is left up to a person skilled in the art as to whether the voice dialog system outputs the conversation prompt in a direct response to the user's question and then answers the user's question or answers the question first and then outputs the conversation prompt.

A user dialog with a voice dialog system could thus also proceed according to the following pattern which again draws on the information illustrated in a table in FIG. 3.

User: “Of which state is Wiesbaden the capital?”

System: “I have found the following answer in response to your question as to state, Wiesbaden: Hessen. Incidentally, did you know that the number of French roulette tables in Wiesbaden is five?”

User: “And where can I play Black Jack?”

System: I have found the following answer in response to your question as to town, Black Jack: Wiesbaden, Bad Wiessee and Baden Baden”.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A method for generating a context-based voice dialog output in a voice dialog system having transactions, each transaction having transaction parameters, each transaction parameter having a plurality of possible parameter values, comprising:
allocating a first parameter value to a transaction parameter of a first transaction;
thematically matching the first parameter value with a matching possible parameter value of a second transaction parameter of a second transaction;
determining a second parameter value for a third transaction parameter of the second transaction; and
generating a voice dialog output which comprises at least the first parameter value and the second parameter value.

2. The method as claimed in claim 1, wherein
the voice dialog system comprises a plurality of voice dialog applications, and
the first transaction is part of a first voice dialog application and the second transaction is part of a second voice dialog application.

3. The method as claimed in claim 1, wherein the method is triggered after the first parameter value has been identified in a user's voice input.

4. The method as claimed in claim 1, wherein the method is triggered after the first parameter value has been identified in a user's voice input and an action associated with the first parameter value has been executed by the voice dialog system.

5. The method for creating a voice dialog system from a plurality of voice dialog applications, comprising:
comparing individual voice dialog applications using a predefinable criterion; and
combining the voice dialog applications which satisfy the predefinable criterion, the voice dialog applications being combined to create the voice dialog system.

6. The method as claimed in claim 5, wherein
in combining the voice dialog applications, transactions and transaction parameters are respectively combined, and
voice dialog applications are combined if the voice dialog applications have matching parameter values.

7. The method as claimed in claim 5, wherein the predefinable criterion is a functional match between the transactions of the voice dialog applications and/or a semantic match between the transaction parameters of the voice dialog applications.

8. The method as claimed in claim 5, wherein
the predefinable criterion is a semantic match between the transaction parameters of the voice dialog applications,
to determine the semantic match between two transaction parameters, a comparison is performed of parameter values, and
a semantic match between associated transaction parameters is established or not as a function of the comparison.

9. The method as claimed in claim 5, wherein
the predefinable criterion is a functional match between the transactions of the voice dialog applications,
to determine the functional match between two transactions, the grammars associated with the transactions are compared with each other, and
a functional match between two transactions is established or not as a function of the comparison.

10. The method as claimed in claim 5, wherein
the predeterminable criterion is a match in vocabularies of the voice dialog applications.

11. The method as claimed in claim 5, wherein
when the voice dialog applications are combined, transactions are combined, and
the transactions combined in the voice dialog system are stored in a common transaction database.

12. The method as claimed in claim 5, wherein
when the voice dialog applications are combined, transaction parameters are combined, and
the transaction parameters combined in the voice dialog system are stored in a common transaction parameter database.

13. The method as claimed in claim 5, wherein
when the voice dialog applications are combined, grammars are combined, and
the grammars combined in the voice dialog system are combined in a common grammar database.

14. A system to generate a context-based voice dialog output in a voice dialog system having transactions, each transaction having transaction parameters, each transaction parameter having a plurality of possible parameter values, comprising:
an allocation unit to allocate a first parameter value to a transaction parameter of a first transaction;
a matching unit to thematically match the first parameter value with a matching possible parameter value of a second transaction parameter of a second transaction;
a determination unit to determine a second parameter value for a third transaction parameter of the second transaction; and
a generation unit to generate a voice dialog output which comprises at least the first parameter value and the second parameter value.

15. The system to create a voice dialog system from a plurality of voice dialog applications, comprising:
a comparison unit to compare individual voice dialog applications using a predefinable criterion; and
a combination unit to combine the voice dialog applications which satisfy the predefinable criterion, the voice dialog applications being combined to create the voice dialog system.
